(19) United States
(12) Patent Application Publication
(10) Pub. No.: US 2018/0009128 A1
(43) Pub. Date: Jan. 11, 2018

(54) GENERATION OF CASTING MOLDS BY ADDITIVE MANUFACTURING

(71) Applicant: Renaissance Services, Inc., Fairborn, OH (US)

(72) Inventors: Dan Z. Sokol, Dayton, OH (US); Ricky Lynn Pressley, Indiantown, FL (US); Bryan Deptowicz, Beavercreek, OH (US); Scott Morris, Columbus, OH (US)

(21) Appl. No.: 15/644,268

(22) Filed: Jul. 7, 2017

Related U.S. Application Data
(60) Provisional application No. 62/359,837, filed on Jul. 8, 2016.

(51) Int. Cl. B28B 1/00; B22C 9/24; B22C 9/10; B28B 17/00

(52) U.S. Cl. CPC B28B 1/001; B28B 17/0081; B22C 9/24; B22C 9/10; B33Y 10/00; B33Y 50/02; B33Y 30/00; B33Y 80/00

(57) ABSTRACT

A disclosed system includes an additive manufacturing printer that performs a layer by layer three-dimensional printing process generating a casting mold based on a three-dimensional numerical specification. The numerical specification is based on a desired casting shape, including internal features such as hollow areas formed by cores, and is further based on a thermo-mechanical model of a casting process. The numerical specification describes variations in material and geometric properties of one or more layers of the casting mold corresponding to variations in the thermal and mechanical properties of the casting processes, as predicted by the thermo-mechanical model. The system may vary the thickness of features of the casting mold, based on predicted cooling rates, to reduce cooling non-uniformities and to provide for controlled, predictable cooling of the casting. The system may further generate trusses and heat sinks in the mold to respectively strengthen and weaken various features of the mold.

### CROSS REFERENCE TO RELATED APPLICATION

Pursuant to 37 C.F.R. §1.78(a)(4), this application claims the benefit of and priority to prior filed co-pending Provisional Application Ser. No. 62/359,837 filed Jul. 8, 2016, which is expressly incorporated herein by reference.

### FIELD OF THE INVENTION

This disclosure generally relates to the formation of molds for castings and particularly to the use of additive manufacturing to generate such molds.

### BACKGROUND OF THE INVENTION

Production of a conventional investment casting starts with generation of a wax pattern that corresponds to geometries and dimensions of a desired finished casting. The wax pattern is then sequentially dipped into a ceramic slurry to form an outer shell. The shell is then hardened through a sintering process and the wax is removed (an example of a “lost wax” process). The remaining hardened shell constitutes the mold and has a cavity that approximates the desired casting shape. Various alloys may then be poured into the mold at high temperatures (up to 3000° F.). Upon solidification of the metal, the mold is broken away to reveal the casting. This process has been used for thousands of years. In modern times, this technique has been widely used to generate mechanical components for aircraft structures (e.g., airfoil and structural components of gas turbine engines), for automotive applications (e.g., engine and body components), for medical devices, etc.

Ceramic slurry dipping for formation of the mold is an imprecise process that often fails to fully account for variations that may occur during the casting process as the molten metal flows and fills the mold. Despite attempts to model the process and account for these variations, it is not unusual for castings produced from conventionally manufactured molds to have problems with both thermal and mechanical properties. Attempts to improve the conventional mold formation process include modifying the slurry during the dipping process, but these efforts may be inhibited by a lack of precision in the slurry process in general.

In addition to issues associated with formation of the mold, generation of the wax pattern may also be a costly and time consuming process. Resulting patterns may be fragile and may be susceptible to mechanical failure during the slurry process, creating flaws in the resulting casting. For these and other reasons, there is a need for improvements to processes used to generate molds for castings.

### SUMMARY OF THE INVENTION

The disclosed embodiments overcome drawbacks associated with conventional casting methods by providing systems, methods, and computer program products that enable use of additive manufacturing to form ceramic molds for casting of mechanical components. For example, disclosed embodiments enable formation of molds for castings having precise geometries and dimensions. Further, disclosed embodiments eliminate a need to form a pattern from wax, foam, or other material to produce a casting mold, thereby enabling generation of molds that are engineered to properly account for thermal and mechanical variations in the casting process to thereby overcome problems associated with conventional processes.

A disclosed system generates a casting mold. The system includes an additive manufacturing printer that performs a layer by layer three-dimensional (3D) printing process to generate the casting mold based on a 3D numerical specification. The numerical specification is based on a desired casting shape, and is further based on a thermo-mechanical model of a casting process that generates a casting. The numerical specification describes variations in material and geometric properties of one or more layers of the casting mold corresponding to variations in the thermal and mechanical properties of the casting process, as predicted by the thermo-mechanical model of the casting process. The system may be configured to vary the design and thicknesses of one or more features of the casting mold based on predicted cooling rates of the casting process to reduce cooling non-uniformities. The system further generates trusses and heat sinks in the mold to respectively strengthen and weaken various features of the mold.

A processor implemented method of generating a casting mold is also disclosed. The method includes receiving, by a processor circuit, input data describing a 3D description of a desired casting shape and receiving input data describing thermal, mechanical, and material properties of a casting material. The method further includes performing a 3D numerical simulation of a casting process to determine predicted spatially dependent cooling rates and mechanical properties of a casting resulting from the casting process, to thereby generate a 3D thermo-mechanical model of the casting process. The method further includes determining locations for placement of adaptive features based on the 3D thermo-mechanical model and generating a 3D numerical specification for the casting mold that describes the desired casting shape and describes placement of the adaptive features. The method further includes controlling an additive manufacturing printer to perform a layer by layer 3D printing process to generate the casting mold based on the 3D numerical specification.

Computer program products are also disclosed. For example, a disclosed non-transitory computer readable storage medium may include computer program instructions stored thereon that, when executed by a processor, cause the processor to perform operations that control an additive manufacturing printer to perform a layer by layer 3D printing process to generate a casting mold based on a 3D numerical specification. The disclosed non-transitory computer readable storage medium may further include computer program instructions stored thereon that, when executed by the processor, cause the processor to generate the thermo-mechanical model of the casting process and to generate the 3D numerical specification for the casting mold based on the generated thermo-mechanical model of the casting process.

The above summary may present a simplified overview of some embodiments of the invention to provide a basic understanding of certain aspects of the invention discussed herein. The summary is not intended to provide an extensive overview of the invention, nor is it intended to identify any key or critical elements, or to delineate the scope of the invention. The sole purpose of the summary is merely to present some concepts in a simplified form as an introduction to the detailed description presented below.

Further embodiments, features, and advantages, as well as the structure and operation of the various embodiments, are described in detail below with reference to the accompanying drawings.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, explain the embodiments of the invention. In the drawings, like reference numbers generally indicate identical, functionally similar, and/or structurally similar elements.

FIG. 1 is a schematic illustration of a part that requires a support structure to provide support in two places as an example of a passive feature, according to an embodiment.

FIG. 2 is a schematic illustration of a cantilever with an angled surface as a further example of a passive feature, according to an embodiment.

FIG. 3 is a schematic illustration of a ceramic mold having a dimensional transition, according to an embodiment.

FIG. 4A illustrates results of a casting simulation that provide information regarding predicted solidification rates, according to an embodiment.

FIG. 4B is a schematic illustration of a plurality of heat sinks designed to have a spatially varying depth based on a prediction of corresponding spatially varying cooling rates, according to an embodiment.

FIG. 4C illustrates a three-dimensional view of a truss structure surrounded above and below by layers of material, according to an embodiment.

FIG. 4D illustrates a three-dimensional view of a truss structure surrounded below by layers of material, according to an embodiment

FIG. 4E illustrates a two-dimensional view of a truss structure.

FIG. 5 is a schematic illustration of a stair-step appearance of layers along a curved surface, according to an embodiment.

FIG. 6 illustrates a first orientation of a casting mold, according to an embodiment.

FIG. 7 illustrates a second orientation of a casting mold, according to an embodiment.

FIG. 8 is a schematic illustration of a mold having an integral core, according to an embodiment.

FIG. 9 illustrates a perspective view of an exemplary mold for casting an airfoil component, according to an embodiment.

FIG. 10 illustrates a cross sectional view of the mold of FIG. 9 illustrating layers of ceramic material, according to an embodiment.

FIG. 11 illustrates a 3D printed casting mold having variations in wall thickness, according to an embodiment.

FIG. 12 illustrates an example of a mold including adaptive features including trusses, according to an embodiment.

FIG. 13 illustrates a complex casting having a mold that is generated in sections, according to an embodiment.

FIG. 14 is a block diagram of an example computer system in which embodiments of the disclosed invention, or portions thereof, may be implemented as computer-readable code, which is executed by one or more processors, according to an embodiment.

### DETAILED DESCRIPTION

This disclosure provides systems, methods, and computer program products that enable generation of casting molds using additive manufacturing (AM) of a ceramic material to form an outer shell and internal features of a mold for a casting. Various embodiments are based on a vat photopolymerization technique of additive manufacturing using digital light processing (DLP). The vat photopolymerization/DLP process uses a three-dimensional (3D) model of the mold, developed using a computer aided design (CAD) system, to render a physical mold. The component to be manufactured may be designed using a CAD or other computer system. Using a 3D image of the component, a computer generates a 3D data representation of a mold for casting the component. The data representation of the mold includes coordinates for forming precise geometries and dimensions on the internal surface of the mold. These internal dimensions enable casting of components having complex patterns.

Computer data representing a 3D mold is transmitted from the computer system to an AM printer. Using the computer-generated mold coordinates, the printer renders the physical mold in a layer by layer build process. In this build process, horizontal thin layers of a vat of liquefied ceramic-loaded polymer material are sequentially exposed to light from a DLP projector or laser source under safelight conditions. The DLP projector/laser source displays successive layers of the image of the 3D model onto the liquefied ceramic-loaded polymer material. At each layer, the exposed liquefied ceramic-loaded polymer hardens and the build platform moves down, allowing another layer of the liquefied ceramic-loaded polymer to be exposed to light. In the vat photopolymerization process, the light moves along the X-Y axes, and the platform containing the mold being generated moves along the Z-axis.

The layer by layer process is repeated until the mold is complete, and raised from the vat, revealing the solidified mold in a pre-sintered green state. The DLP 3D printing process provides a fast, high-resolution technique for printing molds as described herein. Exemplary vat photopolymerization with DLP printers include, without limitation: the Prodways L5000 Promaker moving light DLP system. The mold build may also be performed using a laser printer such as, for example, the 3D Systems Viper Pro SLA System. While the vat photopolymerization process of AM is described with respect to the exemplary embodiment disclosed herein, the ceramic mold formation method of the invention should not be construed as being limited to the vat photopolymerization process. Alternative additive manufacturing processes and printers, including processes and printers presently available as well as processes and printers that may be developed in the future, may be used to form a ceramic casting mold as described herein without departing from the scope of the invention.

An AM printer forms the mold from a material that includes a mixture of ceramic particles and a photopolymer binder material. Upon sintering, the ceramic particles form an integrated body and the binder material is removed via volatilization. An example ceramic material may include (but is not limited to) a silica, zirconia, and alumina mixture. Particle size influences layer thickness, with a diameter in a range of, but not limited to 1-75 microns, with varying particle-size distribution among those particles. Particles may have various shapes including spherical and/or irregular (non-uniform) shapes. Photopolymer material may include photo initiators, dispersants, monomers, and UV absorbers, etc. The disclosed ceramic mold material enables generation of castings for high temperature nickel-based alloys, but is applicable to other alloys, including, but not limited to, aluminum-based alloys, magnesium-based alloys, steel, etc.

Generation of a 3D printed ceramic mold begins with a design definition of the casting or the finished component to be derived from the casting. The design definition may take the form of a two-dimensional drawing or CAD model. An internal envelope of the mold may be established from the CAD model. Design considerations include determination of nominal values for the envelope and designation of allowances for shrinkage and other factors associated with the 3D printing process, taking into account characteristics of specific ceramic materials used to generate the mold. Since shrinkage during the 3D printing process may be anisotropic, specific dimensions (and subsequent shrinkage) for the mold envelope may be influenced by downstream feature definition, including resolution, orientation, and supports, as discussed in greater detail below.

Upon establishment of a mold's inner envelope, specific mold features may be considered and defined. Mold features may be categorized as passive or active. Passive features are those features that are inherent in the casting or finished part design that must be accounted for in the mold design. These features are typically defined in the CAD model and may influence decisions regarding establishment of 3D printing process parameters for the mold. Active features are those that are applied to or incorporated in the 3D printed mold to compensate for thermal or mechanical variations in the casting process. These features are directly influenced by the passive features and are established in a holistic fashion to ensure optimal printing parameters and positive results during post-print activities, including sintering, assembly of mold sections (as appropriate), and realization of tolerances for the casting and/or finished component.

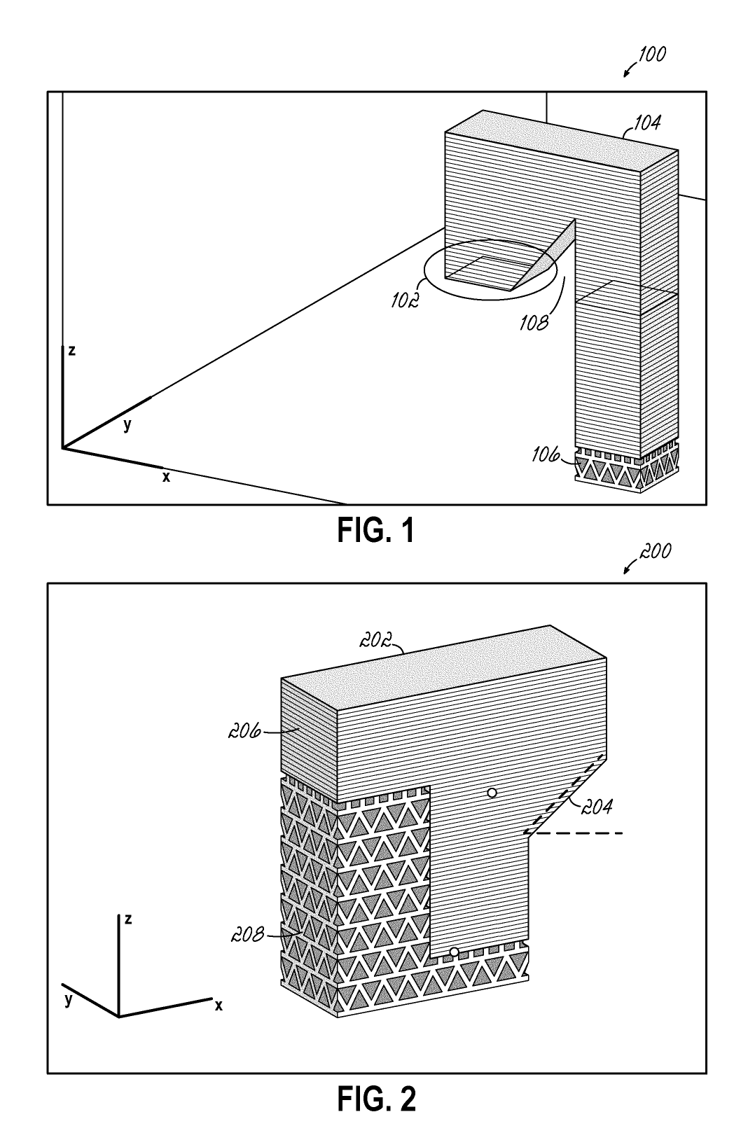

FIG. 1 is a schematic illustration of a part that requires a support structure to provide support in two places as an example of a passive feature, according to an embodiment. Islands 102 are layers of part geometry that would otherwise be unconnected to any other section of the part. They must be anchored to the platform or the part itself. In this example, a part 104 having roughly the shape of a number “7” is desired to be printed. The printing process progresses by building up layers in horizontal planes parallel to the x-y plane, as shown. A support structure 106 anchors the right-hand portion of the part 104 to the build surface. Without a support structure, however, the first few layers of the horizontal feature 102 would not be anchored to the rest of the part 104 due to the presence of the notch 108. To build part 104, a support structure is required below the horizontal feature 104. An example of such a support structure is discussed below with reference to FIG. 2. Failure to properly account for islands 102 during the 3D printing process may lead to debris in resulting parts, may affect geometry and surface finish/visual aesthetics, and may cause failures during the 3D printing process.

FIG. 2 is a schematic illustration of a cantilever 202 with an angled surface 204 as a further example of a passive feature, according to an embodiment. Cantilevers 202 are unsupported horizontal surfaces that must be accounted for and have a direct influence on downstream part orientation and/or the makeup of specific layers during the 3D printing process. Like cantilevers 202, angled surfaces 204 must be addressed through some combination of part orientation, support definition, or makeup of the layers that define the angled surfaces 204. In this example, the angled surface 204 may be built up in a layer by layer process in which each succeeding layer of the angled surface 204 is slightly wider than the preceding layer. However, the horizontal overhang cantilever region cannot be built in a layer by layer process without a support structure 208, as shown.

Another consideration relates to trapped volumes. Trapped volumes may occur in parts having a topology that is such that pockets of liquid resin (i.e., polymer/ceramic material), within the part interior, are unable to communicate with the rest of the liquid resin in the vat. A simple example of a part containing a trapped volume is a cylinder or cylindrical vessel built in the normal right-side-up geometry. While building a layer of the cylindrical vessel. the resin inside cannot equalize any level differences between itself and the resin in the vat. The part has a certain geometry including trapped volumes of unformed material, which allow unformed material being swept in front of the recoater arm, which evenly applies a thin layer of material across the part. Trapped volumes occur when flow back of material occurs underneath the recoater arm in a way that disrupts the layer formation process.

Depending on geometry, a casting may cool at different rates across a given surface area. This may be predicted through simulation or application of engineering knowledge/empirical data. Adaptive layers may enable a more uniform cooling rate and/or may provide for changes in the strength of the mold to eliminate hot tears. According to an embodiment, a single adaptive layer may include heat sinks to address variations in cooling rate and to reduce mold strength. Similarly, trusses may be used to add strength in selected areas. Such adaptive features may span multiple layers and/or may be adjusted based on the needs of a specific region of the mold.

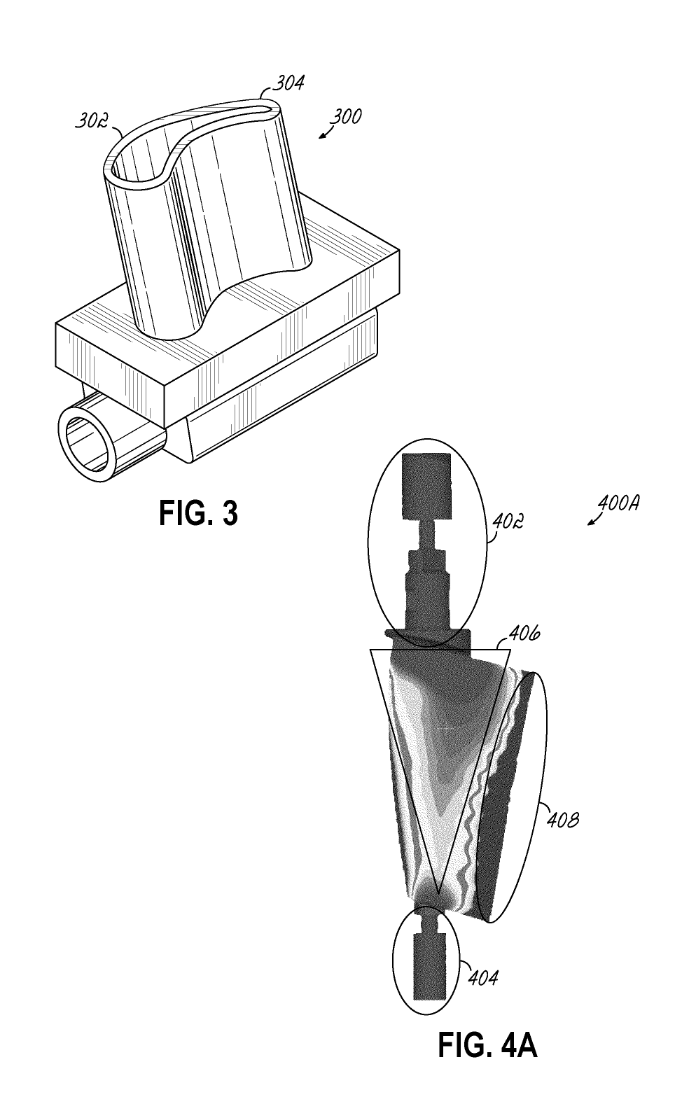

FIG. 3 is a schematic illustration of a mold feature 300 having a dimensional transition, according to an embodiment. It is not uncommon for a casting to transition dimensionally over one or more surfaces. These transitions may be viewed as thick to thin along a single plane or may include sections that transition from “light” to “heavy” along a surface (e.g., a protruding feature such as a boss). Such transitions may affect cooling and shrinkage of metal within the casting. In this example, the mold transitions from a thick (i.e., 3D) region 302 to a thin (approximately two-dimensional) region 304.

From a 3D printed mold perspective, dimensional transitions may be accounted for in order to avoid hot tear defects and other factors that may damage the casting. Orientation, layer definition, establishment of adaptive layers (e.g., trusses and heat sinks) are features that may be considered when accounting for a dimensional transition. Orientation refers to an orientation of the mold with respect to the light source (DLP or laser source) of the AM printer, as discussed in further detail below. Build orientation, when combined with adaptive layers, provides for the optimal combination of supports (to address passive features) and finished mold integrity during both the printing and post-print (e.g., sintering) processes, as described in greater detail below.

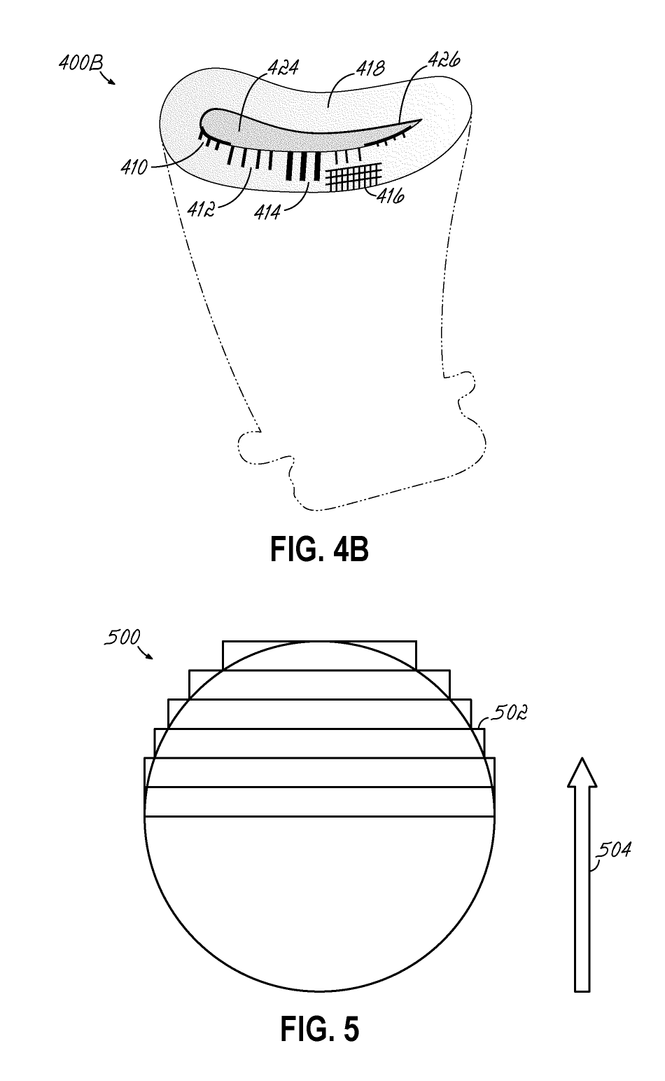

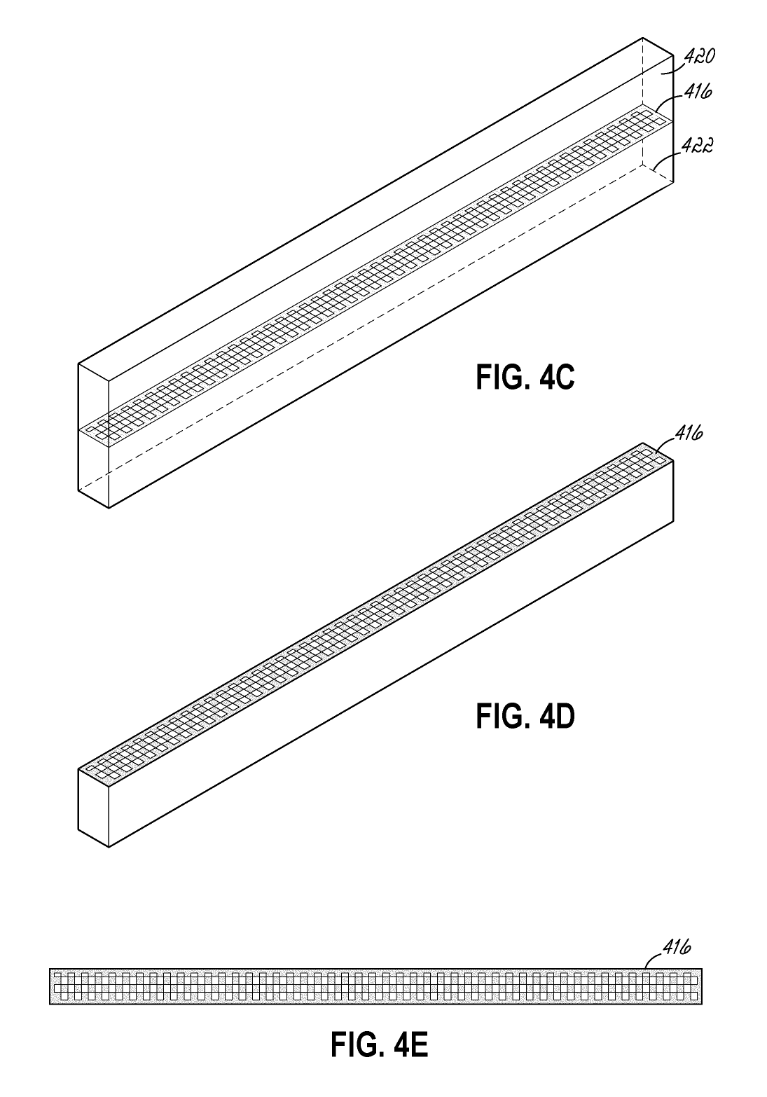

FIG. 4A illustrates results 400A of a casting simulation that provides information regarding predicted solidification rates, according to an embodiment. As a casting cools, various locations in the casting cool and solidify at different rates. Solidification models, such as ProCast (commercially available casting simulation software from ESI Group) may be used to predict cooling rates. Potential casting defects (e.g., hot tears) may be identified in a simulation by studying patterns produced by the predicted solidification pattern. In this example, trusses 402 and 404, may be added to strengthen the mold in certain locations. According to an embodiment, heat sinks may be generated in the mold to have a spatially varying depth to correspond to a predicted spatially varying cooling rate of the casting. Deeper heat sinks may be placed in locations 406 that are predicted to have relatively lower cooling rate, and heat sinks having more shallow depth may be placed in locations 408 that are predicted to cool relatively more rapidly, as described in greater detail below with reference to FIG. 4B.

FIG. 4B is a schematic illustration 400B of a plurality of heat sinks designed to have a spatially varying depth based on a prediction of corresponding spatially varying cooling rates for a part similar to the airfoil mold of FIG. 3, according to an embodiment. Based on a casting simulation, adaptive features (e.g., heat sinks and trusses) enable more uniform cooling and reduce overall strength of the mold in selected areas to prevent hot tears. For example, in a first region 410 heat sinks with minimal depth may be placed in a region of rapid cooling. In a second region 412 additional heat sinks having greater depth may be place in a region having slower cooling. These additional heat sinks in region 412 may be designed to increase the cooling rate. Larger heat sinks may be placed in regions 414 having still-lower cooling rates. As described above, trusses 416 may be placed in certain areas to provide strength for an outer shell to thereby strengthen bonds between layers. Region 418 illustrates a location not requiring any adaptive features such as heat sinks and trusses.

In this example, the black rectangular regions illustrating heat sinks 410, 412, and 414 are notches in the mold that are created when these regions are not illuminated and therefore are not cured. As such, they correspond to hollow regions in which ceramic resin may drain out after the layer by layer build process is completed. The heat sinks 410, 412, and 414 may penetrate several layers and are shown in cross section to the layers in FIG. 4B. Heat sinks 410, 412, and 414 serve two functions: (1) as hollow regions they reduce the mechanical strength of the mold in regions where they are located, and (2) they increase cooling of the mold by allowing air to circulate in the mold in surfaces in proximity to the casting. They may be located directly adjacent to the casting, as shown, or may be displaced from the casting.

In this regard, heat sinks 410, 412, and 414 are void regions that span multiple layers shown in FIG. 4B as being placed adjacent to the internal space 424 of the mold but are isolated from the internal space 424 by an internal surface 426 that separates the internal space 424 from the voided regions of the heat sinks 410, 412, and 414. By making the internal surface 426 thicker, the heat sinks may be displaced to a greater degree from the internal space 424 of the mold. In this way, the heat sinks 410, 412, and 414 may be placed to adjust the resulting heat flow.

FIGS. 4C, 4D, and 4E illustrate formation of a truss structure 416, according to embodiments. In FIG. 4C, a truss layer 416 is shown surrounded by layers of material 420 above the truss layer 416 and by layers of material 422 below the truss layer. A truss layer is generated in one or more layers when a first plurality of regions within the layer are exposed to light to thereby cure the first plurality of regions, while at the same time a second plurality of regions within the same layer is not exposed to light to thereby leave uncured resin in the second plurality of regions. As further layers of material 420 are generated above the truss layer 416, ceramic resin in the second plurality of layers becomes trapped in the structure. When the resulting structure is sintered, the trapped resin forms stronger and more dense regions.

In this way, trusses 416 may be formed to span a plurality of layers by leaving corresponding uncured regions in a plurality of layers to generate 3D voids that trap ceramic resin. In this way, the resulting truss structure 416 strengthens the structure by bonding multiple layers together in much the way that rebar is used to strengthen building materials. FIG. 4E shows a top-down cross section of the truss layer 416. The alternating dark and light regions within the layer correspond to example first and second pluralities of regions that respectively represent cured and uncured regions the form the truss 416. In this example, the uncured regions form a checkerboard pattern within a given layer. By forming a plurality of layers having the same checkerboard pattern gives rise to 3D rectangular bar-shaped regions that span multiple layers which, upon sintering, become corresponding regions of stronger reinforcing material. The checkerboard pattern shown is only one example way to generate a truss. In further embodiments, many other types of truss regions may be generated in the same way by exposing some regions of a layer and leaving other regions of the layer unexposed.

FIG. 5 is a schematic illustration 500 of a stair-step appearance 502 of layers along a curved surface, according to an embodiment. Resolution represents a topography of the mold surface relative to the surface features required for the casting. Resolution can be thought of as the level of surface distortion generated during the 3D printing process, particularly for curved surfaces. Higher resolution of curved surfaces is obtained by orienting those surfaces in the direction of the greatest resolution (e.g., along the X-Y plane resolution is static at 40 microns; along the Z axis, resolution is variable at 25-100 microns). Sloping surfaces that proceed along a slice axis 504 may be layered and may have a “stair-step” appearance 502 shown. According to an embodiment, orientation of the mold may be varied relative to a direction of a light source to reduce the stair-step effect on curved surfaces.

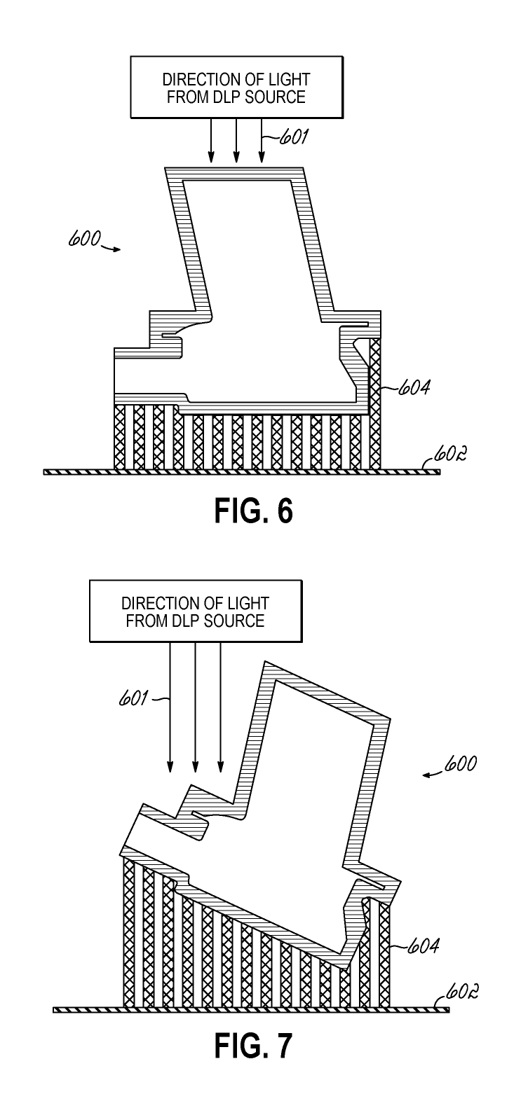

FIGS. 6 and 7 illustrate two orientations of a casting mold 600, according to an embodiment. In FIG. 6, the mold 600 has a first orientation on the 3D printing platform surface 602 with respect to a direction 601 of a light source and in FIG. 7, the mold 600 has a second orientation on the 3D printing platform surface 602 with respect to the direction 601 of the light source.

Orientation may range from perpendicular to the build platform 602 to angled lying virtually flat on the build platform 602. Orientation is influenced by certain internal mold or core surfaces that may result in islands that may be difficult or impossible to be built successfully or which may require support. Because such surfaces exist within the mold cavity, they may not be accessible to enable cleaning and removal of supports and therefore may need to be built in an orientation where the support structures are not needed. With proper choice of orientation, these surfaces may “walk up” during the build process and build angularly in a self-supported fashion as shown in 204 of FIG. 2. Some of these surfaces may be casting surfaces where it would be undesirable and would probably not meet surface finish requirements if those surfaces faced downwards and had to be supported. Part orientation may be based on various tradeoffs between build time, part resolution, surface finish, use of supports, platform size, vat depth, etc.

Supports 604 may be designed as part of the mold 600 definition to address passive features such as islands, cantilevers, and angles (as described above), and to enable optimal resolution and orientation. Supports 604 must be sufficiently strong to support the mold, but must also be sufficiently weak to be broken away from both the build platform and the mold. According to an embodiment, support structures 604 may be printed along with the rest of the mold structure using the same ceramic resin material as used to print the rest of the mold.

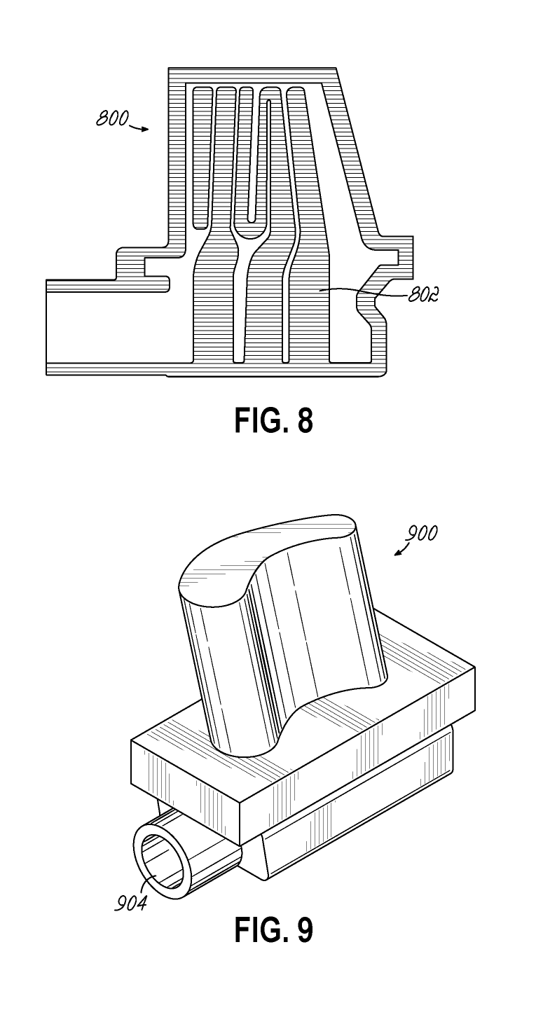

FIG. 8 is a schematic illustration of a mold 800 having an integral core 802, according to an embodiment. In selected applications (e.g., cooled turbine blades, heated inlet guide vanes) a ceramic mold with an integral ceramic core provides a practical solution. Just as some molds cannot be built in certain orientations, the presence of a cored body may either assist in the orientation of the mold or further complicate the orientation, depending on the casting core/shell design. The disclosed approach contrasts with a conventional core/mold relationship (which is derived through use of a wax pattern) which does not benefit from varying the orientation. According to an embodiment, appropriate choice of build orientation combined with use of external and internal support structures (e.g., 604 in FIGS. 6 and 7 and 208 in FIG. 2, respectively) may enable building complicated mold structures (e.g., having cores) that may be difficult or impossible to build using a conventional approach based on the use of a wax form.

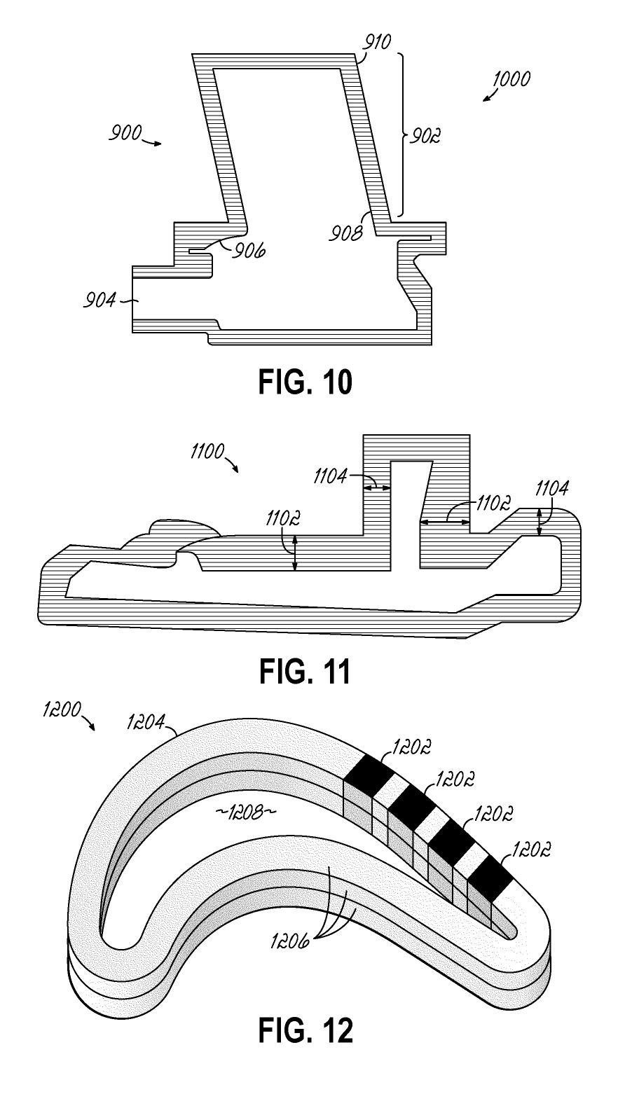

FIG. 9 illustrates a perspective view of an exemplary mold 900 for casting an airfoil component, and FIG. 10 illustrates a cross sectional view 1000 of the mold of FIG. 9 illustrating layers 902 of ceramic material, according to an embodiment. Since a 3D printed mold is produced through successive generation of layers 902, the definition of the layers 902 is a design consideration. The properties of each individual layer may be defined by the light exposure/over-cure (the green strength of the layer is controlled by the light exposure/over-cure, which also results in internal stresses from the curing process).

By increasing the intensity of the light exposure on the layer (overcuring), the layer is strengthened. A stronger layer may be required for supports or to ensure adherence of the support to the printing platform. Conversely, by reducing the amount of overcure, it is possible to generate a larger cross-section that has reduced curl distortion and more dimensional accuracy. Variations in exposure are used in conjunction with heat sinks and trusses (discussed in greater detail below) to impart adaptive properties into the mold. The number of prescribed layers is also a factor in definition of mold walls (i.e., more layers generating thicker walls and fewer layers generating thinner walls) and related considerations, as described below with reference to FIG. 11.

As shown in FIG. 9, a gating 904, through which molten metal may poured during the casting process, is produced as an integral part of the mold 900. The size, shape, and location of the gating 904 may be adjusted as part of the AM process to accommodate the needs of the foundry. The AM-produced mold 900 includes internal features (e.g., features 906 and 908) with the precise geometry and dimensions of the negative features of the finished casting. The AM-produced mold is generated directly from a model of the desired finished casting designed with the aid of computer-aided design (CAD) software. The casting CAD model represents the precise geometry and dimensions of the casting, with an acceptable surface profile. An acceptable surface profile, which is generally specified by the end-user of the casting, may include a surface profile of +/−0.005″ across the surface.

As shown in FIG. 10, an external wall 910 of the mold 10 includes a plurality of AM-generated layers 902. These walls may vary in thickness based on the size and shape of the solids within the combined ceramic-loaded polymer material mixture applied as part of the vat photopolymerization process. The dimensions of the external wall, as well as the thickness and width of individual sections or regions, may also be adjusted as needed to support the casting process, enabling both thin and thick sections to address the thermal and mechanical variations in the casting process. Further, the level of applied energy (i.e., light exposure) during the AM process can be varied to adjust the specific material properties of the layers to further accommodate thermal or mechanical casting requirements. Casting requirements may include (1) a predictable controlled cooling rate as a function of position within a casting, (2) airflow internally or externally to a casting, and (3) material considerations such as to avoid re-crystallization during a directional solidification process. As mentioned above, the internal geometry of the mold is shaped and sized corresponding to negative features of the final casting.

Features of the mold are based on specific physical and performance requirements of the casting and may include geometries and dimensions that include, but are not limited to, precise leading and trailing edges, slots, dovetails, structural supports, and, in some applications, very small diameter holes to enable air to flow through the casting. A consistent surface profile for the casting is maintained through the AM-produced features within the mold internal surface to achieve the acceptable surface profile (i.e., +/−0.005″) as discussed above.

FIG. 11 illustrates a 3D printed casting mold 1100 having variations in wall thickness, according to an embodiment. Wall thicknesses may be chosen to strengthen or weaken mold walls and/or may be chosen based on predicted cooling rates and heat flow characteristics of a casting. In this regard, the thicker wall sections 1102 are placed in areas that cool more rapidly and the thinner wall sections 1104 are placed in areas that cool at a slower rate to make the overall cooling rate more spatially uniform. According to an embodiment, thicker 1102 or thinner 1104 mold sections are determined based on predicted spatially dependent cooling rates derived from a simulation of a casting process.

FIG. 12 illustrates an example of a mold 1200 including adaptive features including trusses 1202, according to an embodiment. Adaptive layering enables the generation of layers that can selectively and precisely add strength or weakness to the mold to address the needs of specific areas of the casting. Adaptive layers are produced through alternating areas of printed material (e.g., a ceramic resin material) and voids, creating systematic interruption in the layer plan ranging from 0.030″ to 0.10″.

As shown in FIG. 12, an external wall 1204 of the mold 1200 is formed through the systematic build-up of individual material layers, as indicated at 1206. Strength may be varied through adjustments to the amount of energy projected into a given material layer, as well as by patterning of the light source through modifications to the CAD model and how the model is conveyed to the 3D printer. In this example, truss layers 1202 are formed as regions that are not exposed to light to leave uncured ceramic resin material that becomes trapped, as described above. These features customize the mold 1200 to adjust to the thermal and mechanical properties of the casting process, while preserving the integrity of the casting geometry within the internal cavity 1208. Adjustments to the mold enable changes to the cooling pattern of the casting to reduce/eliminate such conditions as hot tears and other defects associated with lack of control of the cooling process for the casting. In this example, the trusses 1202 span multiple layers of the structure.

Heat sinks are modeled in such a way that they trap no resin during the 3D printing process. The heat sinks may span across multiple layers and create deliberate, engineered voids in the shell near the inner wall. As such, they are weaker and will more readily break away from the casting during the solidification process, avoiding hot tears. The degree of strength of the heat sink can be adjusted by altering how close it is to the inside of the mold or the thickness/patterning design of the heat sink design. As described above, heat sinks 410, 412, and 414 are placed adjacent to the internal space 424 of the mold but are isolated from the internal space 424 by an internal surface 426 that separates the internal space 424 from the voided regions of the heat sinks 410, 412, and 414. By making the internal surface 426 thicker, the heat sinks may be displaced to a greater degree from the internal space 426 of the mold. In this way, the heat sinks 410, 412, and 414 may displaced to adjust the resulting heat flow.

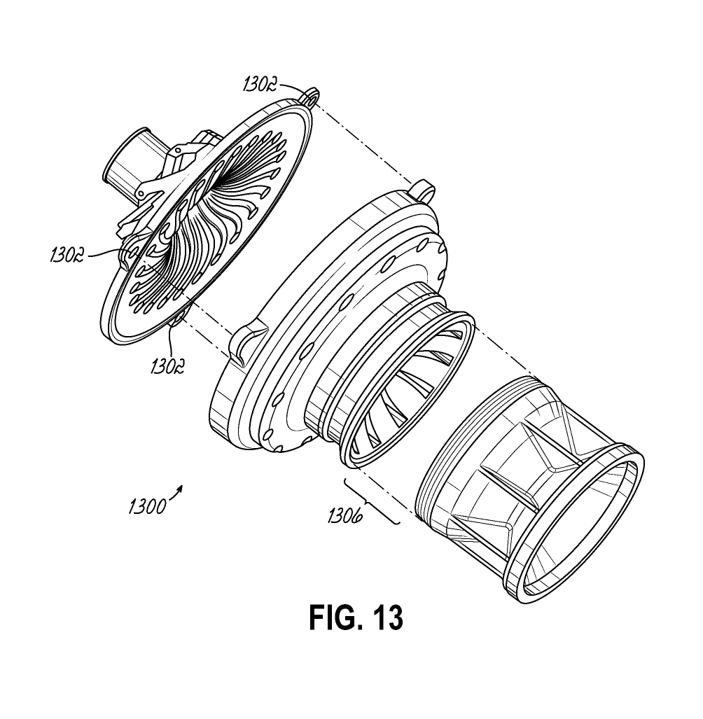

FIG. 13 illustrates a complex casting having a mold 1300 that is generated in sections, according to an embodiment. Based on the size of the casting and the nature of the passive features, 3D printed molds for some applications may be produced in sections and assembled for use by a foundry. The determination as to the number and nature of the mold sections is the result of removing internal passive features that must be supported where the support structures or wall finish cannot be addressed in post processing.

In this example, alignment features 1302 enabling proper clocking between the mold sections may be designed and built into the mold, as shown. Engineered features, such as the adaptive mold features described above, provide adjustments to the mold that enable more uniform cooling, more predictable casting results, and elimination of certain mold-related defects. These engineered features may be included as part of the assembled, multi-section mold 1300, in areas such as indicated at 1306, to provide stress relief, to add strength, and to enable the assembled multi-section mold to adjust for thermal and mechanical variations in the casting process to avoid defects.

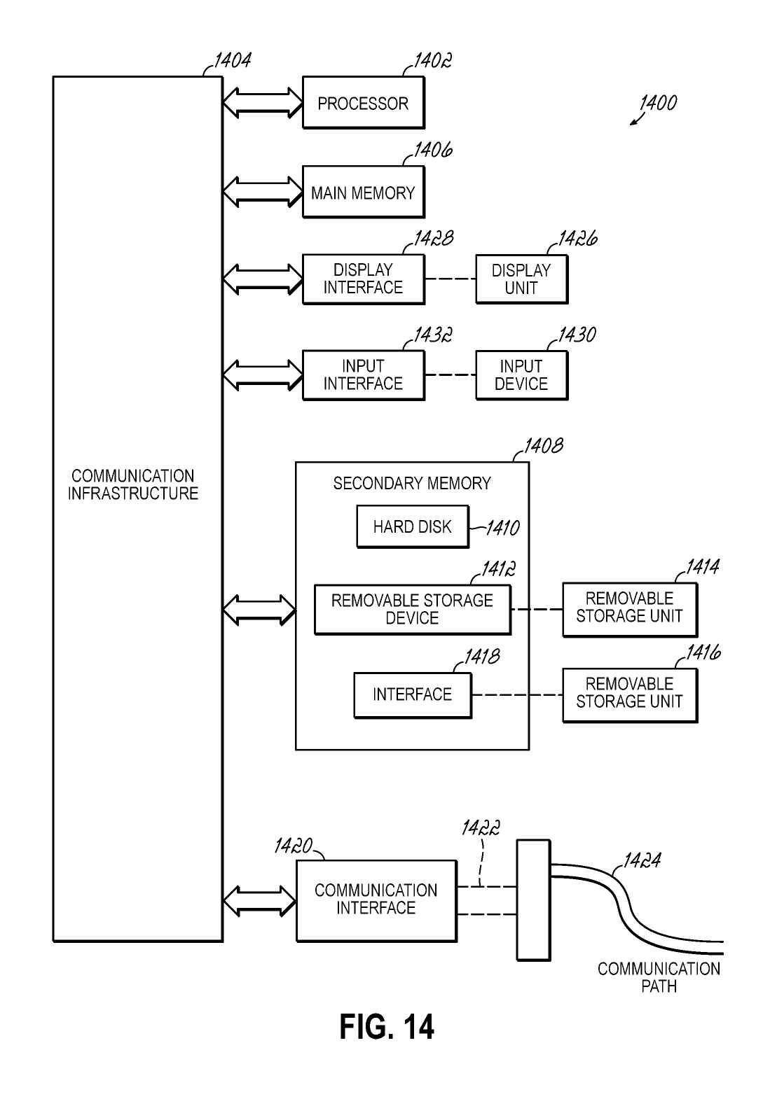

FIG. 14 is a block diagram 1400 of an example computer system 1400 in which embodiments of the disclosed invention, or portions thereof, may be implemented as computer-readable code, which is executed by one or more processors causing the one or more processors to perform operations of the disclosed invention, according to an embodiment. Computer program instructions may be stored on one or more transitory or non-transitory storage devices of computer system 1400.

Systems may include components implemented on computer system 1400 using hardware, software, firmware, tangible computer readable media having instructions stored thereon, or a combination thereof and may be implemented in one or more computer systems or other processing system.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 1400. After reading this description, it will become apparent to persons of ordinary skill in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons of ordinary skill in the relevant art, a computing device for implementing the disclosed invention has at least one processor, such as processor 1402, wherein the processor may be a single processor, a plurality of processors, a processor in a multi-core/multiprocessor system, such system operating alone, or in a cluster of computing devices operating in a cluster or server farm. Processor 1402 may be connected to a communication infrastructure 1404, for example, a bus, message queue, network, or multi-core message-passing scheme.

Computer system 1400 may also include a main memory 1406, for example, random access memory (RAM), and may also include a secondary memory 1408. Secondary memory 1408 may include, for example, a hard disk drive 1410, removable storage drive 1412. Removable storage drive 1412 may include a floppy disk drive, a magnetic tape drive, an optical disk drive, a flash memory, or the like. The removable storage drive 1412 may be configured to read and/or write data to a removable storage unit 1414 in a well-known manner. Removable storage unit 1414 may include a floppy disk, magnetic tape, optical disk, etc., which is read by and written to, by removable storage drive 1412. As will be appreciated by persons of ordinary skill in the relevant art, removable storage unit 1414 may include a computer readable storage medium having computer software (i.e., computer program instructions) and/or data stored thereon.

In alternative implementations, secondary memory 1408 may include other similar devices for allowing computer programs or other instructions to be loaded into computer system 1400. Such devices may include, for example, a removable storage unit 1416 and an interface 1418. Examples of such devices may include a program cartridge and cartridge interface (such as that found in video game devices), a removable memory chip (such as EPROM or PROM) and associated socket, and other removable storage units 1416 and interfaces 1418 which allow software and data to be transferred from the removable storage unit 1416 to computer system 1400.

Computer system 1400 may also include a communications interface 1420. Communications interface 1420 allows software and data to be transferred between computer system 1400 and external devices. Communications interfaces 1420 may include a modem, a network interface (such as an Ethernet card), a communications port, a PCMCIA slot and card, or the like. Software and data transferred via communications interface 1420 may be in the form of signals 1422, which may be electronic, electromagnetic, optical, or other signals capable of being received by communications interface 1420. These signals may be provided to communications interface 1420 via a communications path 1424.

In this document, the terms “computer program storage medium” and “computer usable storage medium” are used to generally refer to storage media such as removable storage unit 1414, removable storage unit 1416, and a hard disk installed in hard disk drive 1410. Computer program storage medium and computer usable storage medium may also refer to memories, such as main memory 1406 and secondary memory 1408, which may be semiconductor memories (e.g., DRAMS, etc.). Computer system 1400 may further include a display unit 1426 that interacts with communication infrastructure 1404 via a display interface 1428. Computer system 1400 may further include a user input device 1430 that interacts with communication infrastructure 1404 via an input interface 1432. A user input device 1430 may include a mouse, trackball, touch screen, or the like.

Computer programs (also called computer control logic or computer program instructions) are stored in main memory 1406 and/or secondary memory 1408. Computer programs may also be received via communications interface 1420. Such computer programs, when executed, enable computer system 1400 to implement embodiments as discussed herein. The computer programs, when executed, enable processor 1402 to implement the processes of embodiments of the invention. Accordingly, such computer programs represent controllers of the computer system 1400. When an embodiment is implemented using software, the software may be stored in a computer program product and loaded into computer system 1400 using removable storage drive 1412, interface 1418, and hard disk drive 1410, or communications interface 1420.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically includes computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. The program code may be distributed using a computer-readable storage medium having computer-readable program instructions stored thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a manner, such that the instructions stored in the computer-readable medium produce an article of manufacture including instructions that implement the functions, acts, and/or operations specified in the flow-charts, sequence diagrams, and/or block diagrams.

The computer program instructions may be provided to one or more processors of a general-purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for describing specific embodiments only and is not intended to be limiting of the embodiments of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes,” “having,” “has,” “with,” or variants thereof are used in either the detailed description or the claims, such terms are intended to be inclusive as is the case with the term “comprising.”

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system that generates a casting mold, the system comprising:
a processor circuit configured to perform operations comprising:
receiving input data describing a three-dimensional (3D) description of a desired casting shape;
receiving input data describing at least one of thermal, mechanical, and material properties of a casting material;
performing a 3D numerical simulation of a casting process to determine predicted spatially dependent cooling rates and mechanical properties of a casting resulting from the casting process, to thereby generate a 3D thermo-mechanical model of the casting process;
determining locations for placement of adaptive features based on the 3D thermo-mechanical model;
generating a 3D numerical specification for the casting mold that describes the desired casting shape and describes placement of the adaptive features; and
controlling an additive manufacturing printer to perform a layer by layer 3D printing process to generate the casting mold based on the 3D numerical specification.

2. The system of claim 1, wherein the processor circuit is further configured:
to generate the 3D numerical specification to describe variations in a thickness of one or more walls of the casting mold, based on the thermo-mechanical model of the casting process, to provide thicker layers in places where the casting is predicted to cool relatively rapidly, and to provide thinner layers in places where the casting is predicted to cool relatively more slowly; and
to control the additive manufacturing printer to vary the thickness of one or more walls in accordance with the 3D numerical specification.

3. The system of claim 1, wherein the processor circuit is further configured:
to generate the 3D numerical specification to describe placement of trusses in the mold in places predicted, by the thermo-mechanical model of the casting process, to encounter stress during the casting process to thereby strengthen the mold in those places; and
to control the additive manufacturing printer to generate trusses in the mold in locations in accordance with the specification.

4. The system of claim 1, wherein the processor circuit is further configured:
to generate the 3D numerical specification to describe placement of heat sinks in the mold, based on the thermo-mechanical model of the casting process, in which heat sinks are placed in locations where the casting is predicted to cool relatively more slowly than in other locations predicted to cool relatively more rapidly; and
to control the additive manufacturing printer to generate heat sinks in the mold in locations in accordance with the specification.

5. The system of claim 1, wherein the processor circuit is further configured:
to generate the 3D numerical specification to describe the casting mold to have a pre-determined orientation relative to a light source of the additive manufacturing printer, based on the thermo-mechanical model of the casting process that predicts the pre-determined orientation as improving the quality of the resulting casting mold relative to other orientations; and
to control the additive manufacturing printer to generate mold to have the pre-determined orientation, in accordance with the specification.

6. A processor implemented method of generating a casting mold, the method comprising:
receiving, by a processor circuit, input data describing a 3D description of a desired casting shape;
receiving input data describing at least one of thermal, mechanical, and material properties of a casting material;
performing a 3D numerical simulation of a casting process to determine predicted spatially dependent cooling rates and mechanical properties of a casting resulting from the casting process, to thereby generate a 3D thermo-mechanical model of the casting process;
determining locations for placement of adaptive features based on the 3D thermo-mechanical model;
generating a 3D numerical specification for the casting mold that describes the desired casting shape and describes placement of the adaptive features; and
controlling an additive manufacturing printer to perform a layer by layer 3D printing process to generate the casting mold based on the 3D numerical specification.

7. The processor implemented method of claim 6, further comprising
generating the 3D numerical specification to describe variations in a thickness of one or more walls of the casting mold, based on the thermo-mechanical model of the casting process, to provide thicker layers in places where the casting is predicted to cool relatively rapidly, and to provide thinner layers in places where the casting is predicted to cool relatively more slowly; and
controlling the additive manufacturing printer to vary the thickness of one or more walls of the casting mold in accordance with the 3D numerical specification.

8. The processor implemented method of claim 6, further comprising
generating the 3D numerical specification to describe placement of trusses in the mold in places predicted, by the thermo-mechanical model of the casting process, to encounter stress during the casting process to thereby strengthen the mold in those places; and
controlling the additive manufacturing printer to generate trusses in the mold in locations in accordance with the specification.

9. The processor implemented method of claim 6, further comprising
generating the 3D numerical specification to describe placement of heat sinks in the mold, based on the thermo-mechanical model of the casting process, in which heat sinks are placed in locations where the casting is predicted to cool relatively more slowly than in other locations predicted to cool relatively more rapidly; and
controlling the additive manufacturing printer to generate heat sinks in the mold in locations in accordance with the specification.

10. The processor implemented method of claim 6, further comprising
generating the 3D numerical specification to describe the casting mold to have a pre-determined orientation relative to a light source of the additive manufacturing printer, based on the thermo-mechanical model of the casting process that predicts the pre-determined orientation as improving the quality of the resulting casting mold relative to other orientations; and
controlling the additive manufacturing printer to generate mold to have the pre-determined orientation, in accordance with the specification.

11. A system that generates a 3D numerical specification that provides instructions to an adaptive manufacturing printer to generate a casting mold, the system comprising:
a processor circuit configured to perform operations comprising:
receiving input data describing a 3D description of a desired casting shape;
receiving input data describing at least one of thermal, mechanical, and material properties of a casting material;
performing a 3D numerical simulation of a casting process to determine predicted spatially dependent cooling rates and mechanical properties of a casting resulting from the casting process, to thereby generate a 3D thermo-mechanical model of the casting process;
determining locations for placement of adaptive features based on the 3D thermo-mechanical model; and
generating the 3D numerical specification for the casting mold that describes the desired casting shape and describes placement of the adaptive features.

12. The system of claim 11, wherein the processor circuit is further configured:
to generate the 3D numerical specification to describe variations in a thickness of one or more walls of the casting mold, based on the thermo-mechanical model of the casting process, to provide thicker layers in places where the casting is predicted to cool relatively rapidly, and to provide thinner layers in places where the casting is predicted to cool relatively more slowly.

13. The system of claim 11, wherein the processor circuit is further configured:
to generate the 3D numerical specification to describe placement of trusses in the mold in places predicted, by the thermo-mechanical model of the casting process, to encounter stress during the casting process to thereby strengthen the mold in those places.

14. The system of claim 11, wherein the processor circuit is further configured:
to generate the 3D numerical specification to describe placement of heat sinks in the mold, based on the thermo-mechanical model of the casting process, in which heat sinks are placed in locations where the casting is predicted to cool relatively more slowly than in other locations predicted to cool relatively more rapidly.

15. The system of claim 11, wherein the processor circuit is further configured:
to generate the 3D numerical specification to describe the casting mold to have a pre-determined orientation relative to a light source of the additive manufacturing printer, based on the thermo-mechanical model of the casting process that predicts the pre-determined orientation as improving the quality of the resulting casting mold relative to other orientations.

16. A processor implemented method of generating a 3D numerical specification that provides instructions to an adaptive manufacturing printer to generate a casting mold, the method comprising:
receiving, by a processor circuit, input data describing a 3D description of a desired casting shape;
receiving input data describing at least one of thermal, mechanical, and material properties of a casting material;
performing a 3D numerical simulation of a casting process to determine predicted spatially dependent cooling rates and mechanical properties of a casting resulting from the casting process, to thereby generate a 3D thermo-mechanical model of the casting process;
determining locations for placement of adaptive features based on the 3D thermo-mechanical model; and
generating the 3D numerical specification for the casting mold that describes the desired casting shape and describes placement of the adaptive features.

17. The processor implemented method of claim 16, further comprising
generating the 3D numerical specification to describe variations in a thickness of one or more walls of the casting mold, based on the thermo-mechanical model of the casting process, to provide thicker layers in places where the casting is predicted to cool relatively rapidly, and to provide thinner layers in places where the casting is predicted to cool relatively more slowly.

18. The processor implemented method of claim 16, further comprising
generating the 3D numerical specification to describe placement of trusses in the mold in places predicted, by the thermo-mechanical model of the casting process, to encounter stress during the casting process to thereby strengthen the mold in those places.

19. The processor implemented method of claim 16, further comprising
generating the 3D numerical specification to describe placement of heat sinks in the mold, based on the thermo-mechanical model of the casting process, in which heat sinks are placed in locations where the casting is predicted to cool relatively more slowly than in other locations predicted to cool relatively more rapidly.

20. The processor implemented method of claim 16, further comprising
generating the 3D numerical specification to describe the casting mold to have a pre-determined orientation relative to a light source of the additive manufacturing printer, based on the thermo-mechanical model of the casting process that predicts the pre-determined orientation as improving the quality of the resulting casting mold relative to other orientations.
